(19) United States
(12) Patent Application Publication
(10) Pub. No.: US 2019/0237880 A1
(43) Pub. Date: Aug. 1, 2019

(54) ANTENNA SYSTEM AND ANTENNA MODULE

(71) Applicant: Delta Networks, Inc., Taoyuan City (TW)

(72) Inventor: Hung-Fu HSU, Taoyuan City (TW)

(21) Appl. No.: 16/041,834

(22) Filed: Jul. 22, 2018

(30) Foreign Application Priority Data
Feb. 1, 2018 (CN) 201810102118.3

(51) Int. Cl. H01Q 19/10; H01Q 3/24; H01Q 15/18

(52) U.S. Cl. CPC H01Q 19/106; H01Q 15/18; H01Q 3/247

(57) ABSTRACT

An antenna system includes reflecting units and antenna units. The reflecting units are arranged on a substrate and are separated from each other, and each of the reflecting units includes a corner with a reflecting unit angle. The antenna units are arranged on the substrate and each of the antenna units is disposed in the corner of its corresponding one of the reflecting units. The reflecting units are configured to adjust radiation patterns of the antenna units.

### RELATED APPLICATIONS

This application claims priority to China Application Serial Number 201810102118.3, filed Feb. 1, 2018, which is herein incorporated by reference.

### BACKGROUND

### Technical Field

The present disclosure relates to an antenna system. More particularly, the present disclosure relates to a beam-switching antenna system.

### Description of Related Art

With the rapid development of wireless communication technology, the need of high data transmission rate gradually increases. Various methods have been presented to perform a wireless communication method with high data transmission rate, and the methods include applications of multiple input multiple output (MIMO) antenna, beamforming technology, smart antenna, etc.

One way to implement the above wireless communication method is beam switching. A common beam-switching design uses a plurality of control diodes to conduct metal reflecting boards to ground, so as to switch the radiation pattern. However, when the metal reflecting boards are not conducted by the control diodes, problems of splitting of radiation pattern, nonobvious directivity and insufficient gain are caused.

Therefore, how to design an antenna system with a focused radiation pattern and obvious directivity to cover different user distribution is an important object to be achieved.

### SUMMARY

The disclosure provides an embodiment of an antenna system, which includes reflecting units and antenna units. The reflecting units are arranged on a substrate separately from each other, and each of the reflecting units includes a corner with a reflecting unit angle. The antenna units are arranged on the substrate and each of the antenna units is disposed in the corner of its corresponding one of the reflecting units. The reflecting units are configured to adjust radiation patterns of the antenna units.

The disclosure further provides an embodiment of an antenna system, which includes a switching circuit and antenna modules. The antenna modules are coupled to the switching circuit and surround the switching circuit, where directions of radiation patterns of the antenna modules extend from the switching circuit. The switching circuit is configured to control the antenna modules to change a radiation pattern of the antenna system.

The disclosure further provides an embodiment of an antenna module, which includes a cross-shaped component, an antenna unit and a reflecting unit. The antenna unit includes two radiation portions, each of the two radiation portions has the same pattern as each of the two ground portions, and the two radiation portions and the two ground portions are arranged on surfaces of the cross-shaped component respectively. The reflecting unit is V-shaped and includes a corner with a reflecting unit angle. The antenna unit is disposed in the corner of the reflecting unit.

As a result, in the present disclosure, the antenna units are arranged in the corners of the v-shaped reflecting units arranged around the switching circuit, and are enabled by the switches in the switching circuit, such that the antenna system can obtain an optimal radiation pattern.

### BRIEF DESCRIPTION OF THE DRAWINGS

The disclosure can be more fully understood by reading the following detailed description of the embodiment, with reference made to the accompanying drawings as follows.

FIG. 1 is a schematic diagram illustrating an antenna system according to some embodiments of this disclosure.

FIG. 2 is a perspective view of an antenna module according to some embodiments of this disclosure.

FIG. 3 is a circuit diagram illustrating the antenna system in FIG. 1 according to some embodiments of this disclosure.

FIG. 4 is a flowchart of an operating method of an antenna system in accordance with one embodiment of the present disclosure.

### DETAILED DESCRIPTION

The following embodiments are disclosed with accompanying diagrams for detailed description. For illustration clarity, many details of practice are explained in the following descriptions. However, it should be understood that these details of practice do not intend to limit the present disclosure. That is, these details of practice are not necessary in parts of embodiments of the present disclosure. Furthermore, for simplifying the drawings, some of the conventional structures and elements are shown with schematic illustrations.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

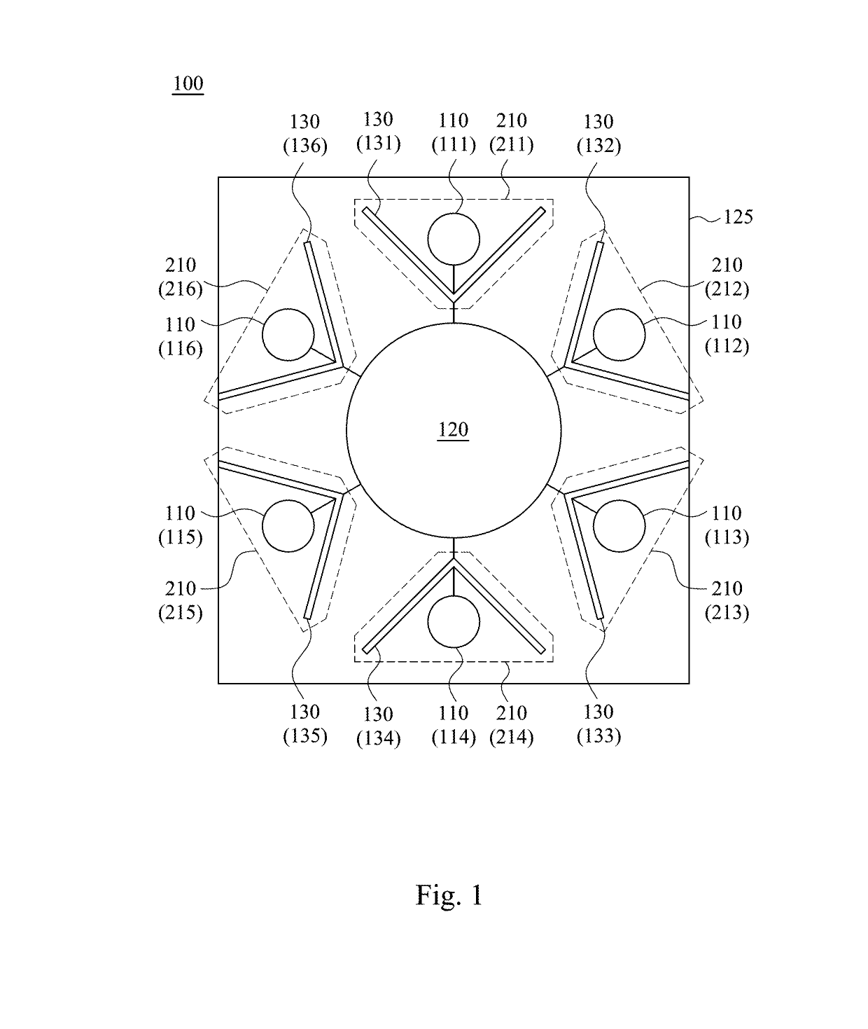

FIG. 1 is a schematic diagram illustrating an antenna system 100 according to some embodiments of this disclosure. In some embodiment, the antenna system 100 of the present disclosure is an antenna system 100 with smart beam switching which can adjust the beam direction of the antenna system 100 according to a position at a user is located, so as to achieve larger received signal strength.

As shown in FIG. 1, in some embodiments, the antenna system 100 includes a number of antenna modules 210 (i.e., antenna modules 211-216), a switching circuit 120 and a substrate 125, in which the antenna modules 210 and the switching circuit 120 are arranged on the substrate 125, and the antenna modules 210 are coupled to the switching circuit 120.

In some embodiments, each of the antenna modules 210 is used to receive or transmit a wireless signal, and the antenna modules 210 have radiation patterns with different directions. In some embodiments, the antenna modules 210 may be controlled by, but not limited to, a communication chip to achieve the aforementioned effects. Various electronic components that can be used to generate radiation patterns with different directions by controlling the switching circuit 120 are within the scope of the present disclosure.

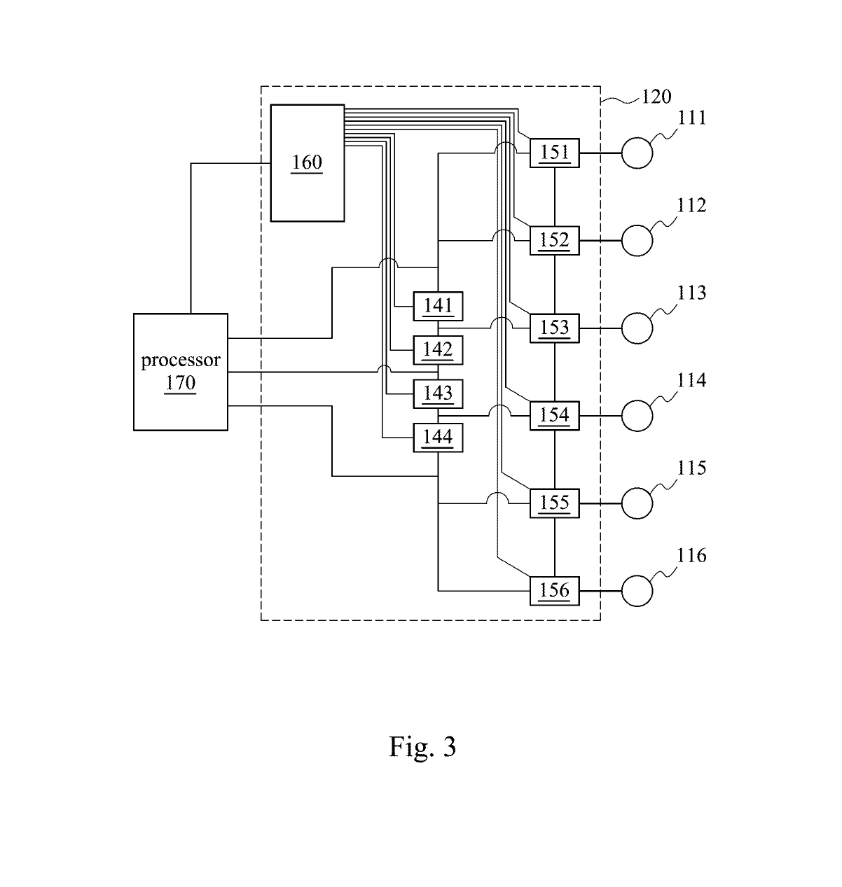

In some embodiments, the switching circuit 120 includes a number of switches, and is used to enable or disable an electrical signal path between at least one of the antenna modules 210 and a signal feeding point based on different statuses, thereby generating radiation patterns by the enabled antenna modules 210, in which the arrangement of the switches of the switching circuit 120 will be described later in detail with reference to FIG. 3. In some embodiments, the switching circuit 120 can be realized by, but not limited to, an integrated circuit (IC). Various electronic components that can used to control the electrical signal path between the antenna modules 210 and the signal feeding point to be enabled or disabled are within the scope of the present disclosure.

In some embodiments, the antenna modules 210 are arranged around the switching circuit 120, and the switching circuit 120 enables or disables one of the antenna module 210 based on different statuses, such that the enabled antenna module 210 operates accordingly, in which the direction of the radiation pattern of the conducted antenna module 210 extends outwardly from the switching circuit 120.

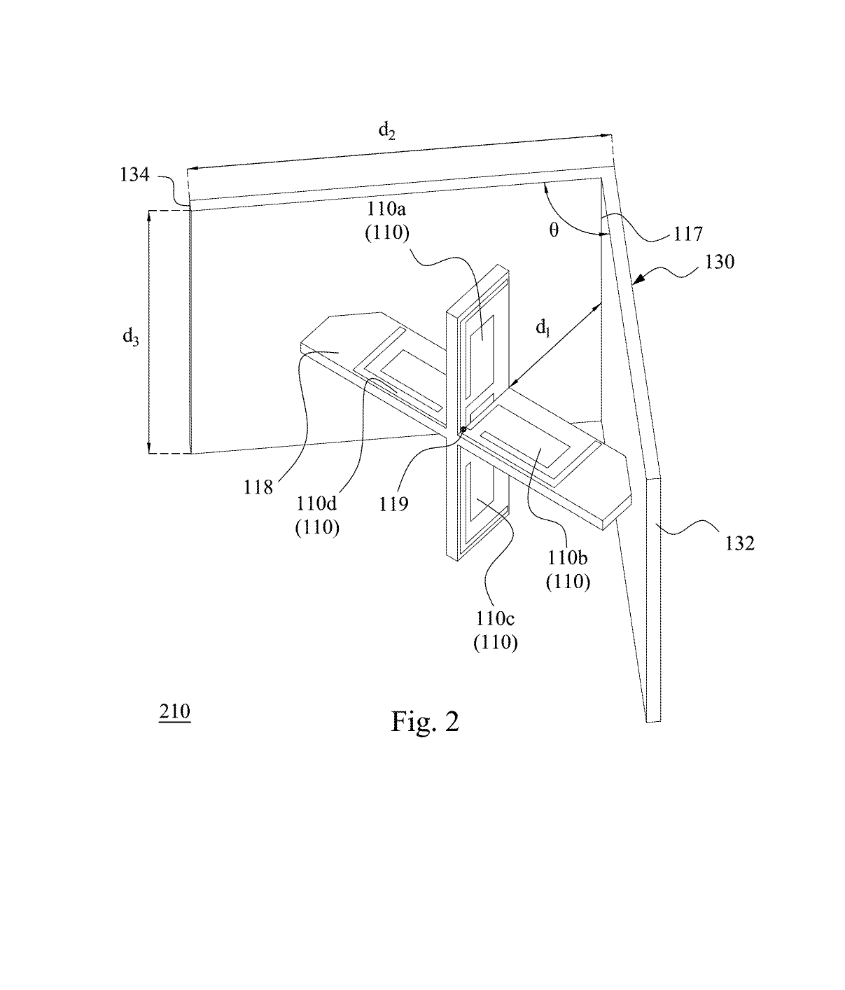

FIG. 2 is a perspective view of an antenna module 210 according to some embodiments of this disclosure. As shown in FIG. 2, in some embodiments, the antenna module 210 includes an antenna unit 110 and a reflecting unit 130, and the antenna unit 110 is disposed in a corner 117 with a reflecting unit angle (as the angle 8 shown in FIG. 2) of the reflecting unit 130.

In some embodiments, the antenna unit 110 is used to receive an electrical signal from a signal feeding point 119, so as to generate a corresponding radiation pattern. In some embodiments, the antenna unit 110 is used to receive a wireless signal from a wireless signal source, so as to establish a wireless signal channel.

In some embodiments, the antenna unit 110 is a dual-band antenna, in which the dual-band includes, but not limited to, 2.4-2.5 GHz or 5.15-5.85 GHz. The antenna unit 110 with any frequency is within the scope of the present disclosure. In some embodiments, the antenna unit 110 can be realized by, but not limited to, a planar inverted F antenna (PIFA), a dipole antenna and a loop antenna. Any circuit element suitable for implementing the antenna unit 110 is within the scope of the present disclosure.

In some embodiments, the antenna unit 110 is, but not limited to, a dual-polarized antenna, such that the antenna unit 110 can receive and transmit both a vertical polarized signal and a horizontal polarized signal at the same time. The antenna unit 110 with single polarization is also within the scope of the present disclosure.

In some embodiments, as shown in FIG. 2, the antenna unit 110 includes a radiation portion 110a, a radiation portion 110b, a ground portion 110c and a ground portion 110d, in which the radiation portion 110a resonates with the ground portion 110c to generate a vertical polarized wave, and the radiation portion 110b resonates with the ground portion 110d to generate a horizontal polarized wave. In some embodiments, the radiation portion 110a is coupled to the radiation portion 110b, the ground portion 110c is coupled to the ground portion 110d, and the signal feeding point 119 is arranged between the radiation portion 110a and the radiation portion 110b. In some embodiments, the radiation portion 110a, the radiation portion 110b, the ground portion 110c and the ground portion 110d have the same patterns, and are arranged on four surfaces of a cross-shaped component 118 respectively. The pattern of each of the radiation portion 110a, the radiation portion 110b, the ground portion 110c and the ground portion 110d includes a long portion and a short portion (not shown), so as to implement a dual-band antenna structure. In some embodiments, two respective corners of two surfaces of the cross-shaped component 118 (i.e., the surface includes the radiation portion 110b and the surface includes the ground portion 110d) are embedded in the reflecting unit 130, such that the connection between the antenna unit 110 and the reflecting unit 130 is more stable, and the beam direction of the antenna system 100 is further stabilized.

In some embodiments, the reflecting unit 130 has the corner 117 with the reflecting unit angle θ, and is used to adjust the radiation pattern generated by the antenna unit 110. In some embodiments, the reflecting unit 130 includes two reflecting boards 132 and 134, and ends of the two reflecting boards 132 and 134 are connected to each other to form the corner 117. In some embodiments, the reflecting unit 130 is, but not limited to, V-shaped. Various shapes of the reflecting boards 132 and 134, such as a planar shape, a U-shape and an arc-shape that can be used to adjust the radiation pattern generated by the antenna unit 110 are within the scope of the present disclosure. In this embodiment, the reflecting unit 130 is disposed in a manner to reduce radiation radiated from the back of the antenna unit 110 and to achieve better isolation between the antenna units 110.

As shown in FIG. 2, in some embodiments, a length d1 is a distance between the antenna unit 110 and the corner 117 of the reflecting unit 130, a length d2 is a length of each of the reflecting boards 132 and 134 of the reflecting unit 130, and a length d3 is a width of the reflecting boards 132 and 134 of the reflecting unit 130. In some embodiments, the wavelength (λ) used to represent the length d1 is the light speed divided by a center frequency (i.e., when the dual-band includes 2.4-2.5 GHz or 5.15-5.85 GHz, the center frequency of 2.4-2.5 GHz is 2.45 GHz), and the length d1 is, but not limited to, 0.2 times of the wavelength (0.2 λ). Any value of the length d1 between 0.1 times of the wavelength to 0.6 times of the wavelength (i.e., from 0.1 λ to 0.6 λ) is within the scope of the present disclosure. In some embodiments, the length d2 is larger than 1.58 times of the length d1, the range of the length d2 is from 0.15 times of the wavelength to 1.05 times of the wavelength (i.e., from 0.15 λ to 1.05 λ), and the length d3 is 0.25 times of the wavelength (i.e., 0.25 λ). In some embodiments, the aforementioned wavelength (λ) is the wavelength of the signal used by the antenna unit 110 for wireless transmission. In some embodiments, if the antenna system 100 includes six antenna units 110 and six reflecting units 130, and the antenna units 110 and the reflecting units 130 are arranged as shown in FIG. 1, the antenna system 100 generates an omni-directional radiation pattern when all the antenna units 110 in the antenna system 100 are enabled and each of the reflecting unit angles θ of the corners 117 of the reflecting units 130 is, but not limited to, 90 degrees. In other words, the radiation pattern of the antenna system 100 covers a range of 360 degrees. Various ranges of the reflecting unit angle θ of the corner 117 of each of the reflecting units 130 between any two of such as 45 degrees, 90 degrees and 180 degrees are within the scope of the present disclosure.

TABLE 1

| | | Peak gain of | Peak gain of |
|---|---|---|---|
| Reflecting | | the antenna | the antenna |
| unit | Length | unit 110 with its | unit 110 with its |
| angles θ | d1 | frequency | frequency |
| (degree) | (λ) | 2.45 GHz (dBi) | 5.5 GHz (dBi) |
| 45 | 0.21 | 3.96 | 7.09 |
| 45 | 0.4 | 2.49 | 5.44 |
| 90 | 0.25 | 4.41 | 6.52 |
| 90 | 0.49 | 3.73 | 5.64 |
| 180 | 0.25 | 4.89 | 4.99 |

Next, reference is made to FIG. 2 and Table 1, in which Table 1 shows the peak gain of the antenna unit 110 operated under the center frequencies of 2.45 GHz and 5.5 GHz respectively with different configurations of the reflecting unit angle θ and the length d1 in the antenna system 100. As shown in Table 1, different peak gains are obtained with different reflecting unit angles θ and different lengths d1. When the reflecting unit angle θ is fixed, the distance between the antenna unit 110 and the reflecting unit 130 (i.e., the length d1) is negatively correlated with the peak gain of the antenna unit 110. However, when the antenna unit 110 is operated in frequency band between 2.4-2.5 GHz and the length d1 is fixed, the peak gain of the antenna unit 110 is positively correlated with the reflecting unit angle θ. When the antenna unit 110 is operated within frequency band between 5.15-5.85 GHz and the length d1 is fixed, the peak gain of the antenna unit 110 is negatively correlated with the reflecting unit angle θ. Therefore, when the operating frequency of the antenna unit 110 is determined, the relationship of the reflecting unit 130 and the antenna unit 110 in the antenna system 100 can be designed to obtain a better peak gain.

FIG. 3 is a circuit diagram illustrating the antenna system 100 in FIG. 1 according to some embodiments of this disclosure. As shown in FIG. 1 and FIG. 3, in some embodiments, the antenna system 100 includes a processor 170, and the aforementioned antenna units 110 are represented by the antenna units 111, 112, 113, 114, 115 and 116, in which the processor 170 is coupled to the switching circuit 120, and the switching circuit 120 is further coupled to the antenna units 111, 112, 113, 114, 115 and 116.

In some embodiments, the switching circuit 120 is used to select at least one of the antenna units 111-116 to perform wireless communication with a user. In some embodiments, the switching circuit 120 can be realized by, but not limited to, an electronic chip. Various circuits that can be used to select at least one transmission antenna from the antenna units 111-116 are within the scope of the present disclosure.

In some embodiments, the processor 170 is used to receive electrical signals from the switching circuit 120 and calculate at least one of the antenna units 111-116 performing wireless transmission. In some embodiments, the processor 170 is used to transmit the electrical signal received from the signal feeding point to the switching circuit 120. In some embodiments, the processor 170 can be realized by, but not limited to, a microprocessor with communication capability. Various communication chips suitable for implementing the processor 170 are within the scope of the present disclosure.

In some embodiments, when the antenna units 111-116 all function as receiving antennas, the antenna units 111-116 convert six received signals into six electrical signals respectively and input the six electrical signals into the switching circuit 120, and the switching circuit 120 generates and outputs at most three corresponding electrical signals to the processor 170. In some embodiments, when the antenna units 111-116 all function as transmitting antennas, the processor 170 inputs at most three corresponding electrical signals to the switching circuit 120, and the switching circuit 120 outputs the at most three corresponding electrical signals to the antenna units 111-116, so as to transmit a corresponding signal to the user who wants to perform wireless communication with the antenna system 100. In some embodiments, the processor 170 receives or transmits at most three electrical signals because the three electrical signals correspond to three of the antenna units 111 to 116, and the main beam width of the radiation patterns of the three of the antenna units 111-116 corresponds to one half of the radiation space in this embodiment. Therefore, the reception and transmission of at most three electrical signals enable the antenna system 100 to be directional. However, the number of the electrical signals received or transmitted by the processor 170 is not limited to 3. Various numbers of electrical signals as the input or output are within the scope of the present disclosure.

As shown in FIG. 3, in some embodiments, the switching circuit 120 includes the control unit 160 and, in which the control unit 160 is coupled to the switches 141-144 and 151-156 via a number of traces respectively. In some embodiments, the switch 151 is coupled to the antenna unit 111, the switch 152 is coupled to the antenna unit 112, the switch 153 is coupled to the antenna unit 113, the switch 154 is coupled to the antenna unit 114, the switch 155 is coupled to the antenna unit 115, the switch 156 is coupled to the antenna unit 116, the switch 141 is coupled between the switch 152 and the switch 153, the switch 142 is coupled between the switch 143 and the switch 153, the switch 143 is coupled between the switch 142 and the switch 154, and the switch 144 is coupled between the switch 154 and the switch 155.

In some embodiments, the switches 141-144 and 151-156 are used to enable or disable the corresponding antenna units 110 to omni-directionally transceive the wireless signal in any direction. In some embodiments, the switches 141-144 and 151-156 can be realized by, but not limited to, resistive switches or diodes. Various electronic components that can be used to control current flow through or blocked are within the scope of the present disclosure.

In some embodiments, the control unit 160 is used to control the switches 141-144 and 151-156, so as to enable or disable the connection between the processor 170 and at least one of the antenna units 111-116. In some embodiments, the control unit 160 can be realized by, but not limited to, an integrated circuit (IC). Various electronic devices that can be used to control the switches 141-144 and 151-156 are within the scope of the present disclosure.

In practical applications, the processor 170 transmits a control signal to the control unit 160, such that the control unit 160 can control the switches 141-144 and 151-156 to enable or disable at least one of the antenna units 111-116. For example, when desiring to perform the wireless communication with the signal source by using the antenna units 113, 115 and 116, the processor 170 transmits a control signal to the control unit 160 to turn on the switches 141, 143, 144, 153, 155, 156, and to turn off the switches 142, 151, 152 and 154. Under this situation, the antenna system 100 can perform wireless communication with the signal source via the antenna units 113, 115 and 116.

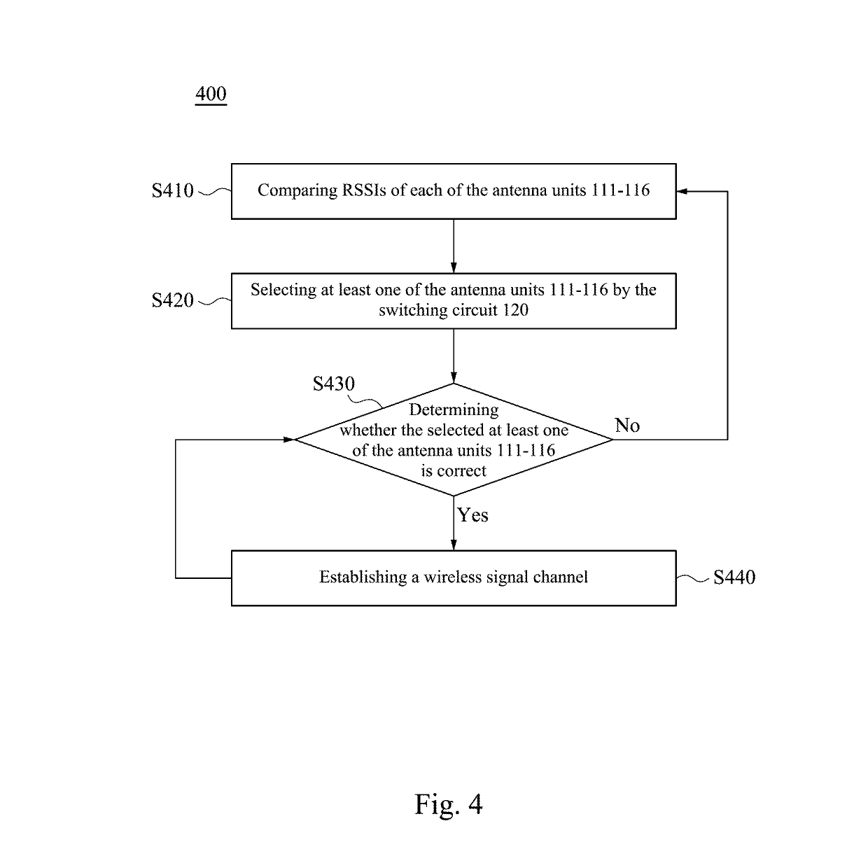

FIG. 4 is a flowchart of an operating method 400 of an antenna system 100 in accordance with one embodiment of the present disclosure. For the sake of convenience and clarity, the following description is made with reference to FIG. 3 and FIG. 4. As shown in FIG. 3 and FIG. 4, in some embodiments, operation S410 is first performed to compare the received signal strength indicators (RSSI) of the antenna units 111-116. In this operation, the control unit 160 controls the switches 141-144 and 151-156 to turn on, such that the corresponding antenna units 111-116 may receive the wireless signals from the signal source respectively. The control unit 160 then transmits the electrical signals to the processor 170, and the processor 170 compares the RSSIs of the electrical signals respectively. For example, at the first time point, the control unit 160 turns on the switches 141-144 and 151-153 such that each of the antenna units 111, 112 and 113 transmits the electrical signal corresponding to the received wireless signal to the processor 170. At the second time point, the control unit 160 turns on the switches 141-144 and 154-156 such that each of the antenna units 114, 115 and 116 transmits the electrical signal corresponding to the received wireless signal to the processor 170. The processor 170 then compares the RSSIs corresponding to the six electrical signals.

In this operation, the processor 170 compares, but not limited to, the RSSIs corresponding to the antenna units 110. The processor 170 can also compare the data rates or the number of spatial streams corresponding to the antenna units 110. Various indicators that can be used to represent the data transmission between the antenna units 110 and the signal source are within the scope of the present disclosure.

Next, operation S420 is performed to select at least one of the antenna units 111-116 by using the switching circuit 120. In this operation, the processor 170 transmits a control signal to the control unit 160 according to the comparison result of operation S410, such that the control unit 160 turns on the corresponding ones of the switches 141-144 and 151-156 to select the at least one of the antenna units 111-116.

Next, operation S430 is performed to determine whether the selected one of the antenna units 111-116 is correct. In this operation, the processor 170 determines whether the selected one of the antenna units 111-116 is correct according to whether the wireless communication between the selected one of the antenna units 111-116 and the signal source is stable. In some embodiments, the method for the processor 170 to determine whether the wireless communication is stable includes, but not limited to, to determine whether the signal transmission process is interrupted, to determine whether the message is received before timeout and to determine whether a negative acknowledgement (NACK) is received. Various methods for determining whether wireless communication is stable or not are within the scope of the present disclosure.

In some embodiments, when the determination result of operation S430 is “yes”, operation S440 is performed to establish a wireless signal channel. In this operation, the antenna system 100 establishes the wireless signal channel through the at least one of the antenna units 111-116 selected in the operation S420, so as to perform data transmission with the signal source.

In some embodiments, when the determination result of operation S430 is “no”, operation S410 is performed to compare RSSIs of the antenna units 111-116 again, and operation S420 is then performed.

As a result, in the present disclosure, the antenna units 111-116 are arranged within the corner 117 of the v-shaped reflecting units 130 arranged around the switching circuit 120, and are enabled by the switches 141-144 and 151-156 in the switching circuit 120, such that the antenna system 100 can obtain an optimal radiation pattern.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An antenna system, comprising:
a plurality of reflecting units arranged on a substrate separately from each other, wherein each of the reflecting units comprises a corner with a reflecting unit angle; and
a plurality of antenna units arranged on the substrate and each of the antenna units disposed in the corner of its corresponding one of the reflecting units,
wherein the reflecting units are configured to adjust radiation patterns of the antenna units.

2. The antenna system of claim 1 further comprising:
a plurality of switches coupled to the antenna units,
wherein the switches are configured to selectively enable or disable an electrical signal path between one of the antenna units and a signal feeding point.

3. The antenna system of claim 1, wherein each of the reflecting units comprises:
two reflecting boards, wherein one ends of the two reflecting boards are connected to each other to form the corner with the reflecting unit angle.

4. The antenna system of claim 1, wherein each of the reflecting units is V-shaped.

5. The antenna system of claim 1, wherein a distance between one of the antenna units and the corner of the corresponding one of the reflecting units is in a range from 0.1 times of a wavelength to 0.6 times of the wavelength.

6. The antenna system of claim 1, wherein the reflecting unit angle of the corner in each of the reflecting units is in a range from 45 degrees to 180 degrees.

7. The antenna system of claim 1, wherein one of the antenna units comprises two radiation portions and two ground portions, each of the two radiation portions has the same pattern as each of the two ground portions, and the two radiation portions and the two ground portions are arranged on a plurality of surfaces of a cross-shaped component respectively.

8. An antenna system, comprising:
a switching circuit; and
a plurality of antenna modules coupled to the switching circuit and surrounding the switching circuit, wherein directions of radiation patterns of the antenna modules extend from the switching circuit,
wherein the switching circuit is configured to control the antenna modules to change a radiation pattern of the antenna system.

9. The antenna system of claim 8, wherein each of the antenna modules comprises:
an antenna unit coupled to the switching circuit and selectively enabling or disabling an electrical signal path between the antenna unit and a signal feeding point via the switching circuit.

10. The antenna system of claim 9, wherein each of the antenna modules further comprises:
a reflecting unit configured to adjust a radiation pattern of the antenna unit, wherein the reflecting unit is V-shaped and comprises a corner with a reflecting unit angle,
wherein the antenna unit is disposed in the corner of the reflecting unit.

11. An antenna module, comprising:
a cross-shaped component having a plurality of surfaces;
an antenna unit comprising two radiation portions and two ground portions, wherein each of the two radiation portions has the same pattern as each of the two ground portions, and the two radiation portions and the two ground portions are arranged on the surfaces of the cross-shaped component respectively; and
a reflecting unit being V-shaped and comprising a corner with a reflecting unit angle,
wherein the antenna unit is disposed in the corner of the reflecting unit.

12. The antenna module of claim 11, wherein a distance between the antenna unit and the corner of the reflecting unit is in a range from 0.1 times of a wavelength to 0.6 times of the wavelength.

13. The antenna module of claim 11, wherein the reflecting unit angle of the corner in the reflecting unit is in a range from 45 degrees to 180 degrees.
